(19) United States
(12) Patent Application Publication
(10) Pub. No.: US 2009/0091184 A1
(43) Pub. Date: Apr. 9, 2009

(54) Motor Vehicle

(75) Inventor: Axel Rudorff, Berlin (DE)

Correspondence Address: CONTINENTAL TEVES, INC., ONE CONTINENTAL DRIVE, AUBURN HILLLS, MI, 48326-1581, US

(73) Assignee: TEMIC AUTOMOTIVE ELECTRIC MOTORS GMBH, Berlin (DE)

(21) Appl. No.: 12/282,553

(22) PCT Filed: Feb. 21, 2007
(86) PCT No.: PCT/DE2007/000326

§ 371 Date: Sep. 11, 2008

(30) Foreign Application Priority Data
Mar. 20, 2006 (DE) 10 2006 013 126.6

(51) Int. Cl. B60L 1/00

(52) U.S. Cl. 307/9.1

(57) ABSTRACT

A motor vehicle with a number of consumers (10) which are operated with electric energy via the on-board network (8) and a main energy storage unit (4) and a capacitive auxiliary energy storage unit (6) is designed to enable a greater range of utilisation of electric energy and a significant increase in the service life of the main energy storage unit (4). For this purpose, according to the invention, the auxiliary energy storage unit (6) is connected on the consumer side with the on-board network (8) via a four-quadrant DCDC converter (14).

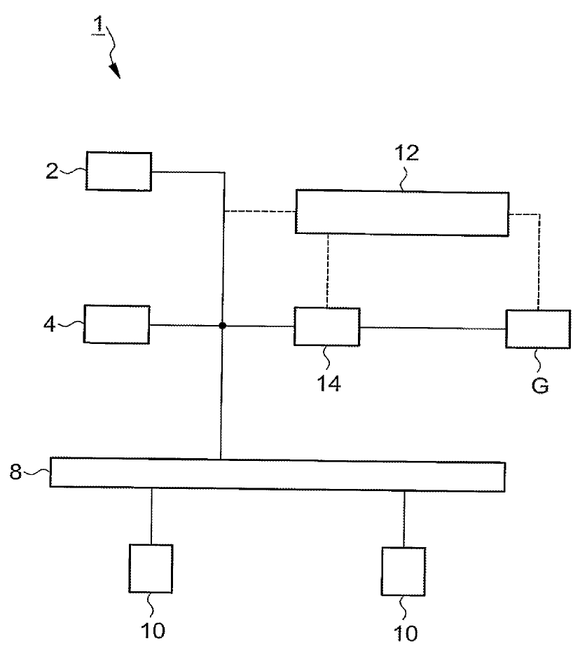

### BACKGROUND OF THE INVENTION

The invention relates to a motor vehicle with a number of consumers which are operated with electric energy via the on-board network and a control device which controls the energy supply and a main energy storage unit and a capacitive auxiliary energy storage unit.

Due to the increasing range of functions of modern motor vehicles, huge demands are made of the on-board networks of these motor vehicles. This is reflected in an increasing number of electric consumers and an increase in the use of electric energy. The load on a motor vehicle on-board network of this type typically fluctuates significantly at different times. In terms of further development, it can be assumed that the load on on-board networks in modern motor vehicles will continue to increase.

The classic form of energy storage unit in motor vehicles is based on the conversion of electric energy into chemical energy. The electric energy is generated during favourable operating states by a generator such as a dynamo, and is stored for consumption during unfavourable operating states in the electro-chemical storage unit, which is usually de-signed as a battery. Due to the aforementioned significant fluctuation of the load on the on-board network at different times, a frequent alternation results between the storage charging and discharging operating states. The resulting frequent cycling of the classic energy storage unit subjects said unit to a very heavy load, depending on the arrangement, and creates corresponding disadvantages for its service life.

A further cause of severe cycling results from the function which is for example assigned in a hybrid motor vehicle to the energy supply unit of converting braking energy by recuperation into electric energy, and feeding this into the on-board network or storing it for later use. The object of this method is to use energy which has already been generated and to reduce fuel consumption.

In order to increase the service life of the aforementioned main energy storage unit, there is the option of coupling a further energy storage unit, referred to as an auxiliary energy storage unit, to the on-board network. The function of the auxiliary energy storage unit is to operate the dynamic loads in order to thus reduce the cycling of the main energy storage unit. A further function of the auxiliary energy storage unit is to store the energy which is not to be consumed immediately, which is obtained for example by means of recuperation.

Cycle-resistant technologies such as a capacitive energy storage unit obtained by means of double-layer capacitors are used as auxiliary energy storage units. Other cycle-resistant storage technologies on an electro-chemical basis are also possible.

Usually, the auxiliary energy storage unit is operated at a voltage level which is greater than or equal to the on-board network voltage of the motor vehicle. The voltage level of the auxiliary energy storage unit increases during charging as compared to the main energy storage unit, in order to decrease again to the level of the main energy storage unit by discharging.

The object of the invention is to provide a motor vehicle of the type described above which enables a greater range of utilisation of electric energy and a significant increase in the service life of the main energy storage unit.

### SUMMARY OF THE INVENTION

This object is attained according to the invention by connecting the auxiliary energy storage unit on the consumer side with the on-board network via a four-quadrant DCDC converter.

Advantageous embodiments of the invention are the subject of the subordinate claims.

The invention is based on the consideration that every energy storage unit has a potential of electric energy. This potential is however only fully utilised up to a specified voltage level. With an auxiliary energy storage unit, this is generally identical with the voltage level of the main energy storage unit. A greater range of utilisation of electric energy can for example be achieved by using the energy up to an energy level with an absolute value of zero.

In order to make the fullest possible use of the electric energy stored in the auxiliary energy storage unit, and thus to be able to keep the main energy storage unit essentially free of cyclical loads, the four-quadrant DCDC converter is advantageously pre-set in such a manner that it can discharge the electric energy stored in the capacitive auxiliary energy storage unit down to a voltage level which lies below the voltage level of the main energy storage unit, in the best design, to a voltage level of 0V.

The advantages attained by means of the invention are in particular that the main energy storage unit is essentially freed from cyclical loads and its service life is thus increased as opposed to the standard application, and the utilisable energy content of the auxiliary energy storage unit is significantly increased. Furthermore, a reduction in installation space and cost is also possible.

An exemplary embodiment of the invention will be explained in greater detail with reference to a drawing.

### BRIEF DESCRIPTION OF THE DRAWING

The FIGURE therein shows a schematic view of the electric system of a motor vehicle.

### DETAILED DESCRIPTION OF THE DRAWING

The electric system 1 of a motor vehicle comprises a generator 2, which when the motor vehicle is driven by means of the internal combustion engine not shown here converts the mechanical energy into electric energy, or recuperates it in certain operating states. For this purpose, excess electric energy which is generated during favourable operating states of the motor vehicle is typically stored, for example by means of recuperation in a main energy storage unit 4, for later consumption during phases when the operating state is unfavourable. The main energy storage unit 4 is in most cases designed as a battery, the function of which is based on electro-chemical processes.

Usually, the electric consumers 10 of the on-board network 8 are supplied via the electric energy stored in the main energy storage unit 4 or directly via the generator 2.

In order to relieve the main energy storage unit 4 from the typical cyclical loads for driving a motor vehicle and for the consumption and generation of electric energy, which can have a negative impact on its service life, the electric system 1 also comprises, alongside the main energy storage unit 4, an auxiliary energy storage unit 6, which can both feed the on-board network 8 with a number of consumers 10 and store the energy which is generated or recuperated by the generator 2. Here, the auxiliary energy storage unit 6 can be charged to a voltage level which is higher than the voltage level of the main energy storage unit 4.

In order to control the flow of energy for consumption and storage, a control device 12 is provided which records and assesses the voltage level in the main energy storage unit 4 and in the auxiliary energy storage unit 6, and taking account of the result of the assessment, controls the feed of energy and the removal of electric energy from the auxiliary energy storage unit 6, for example the supply of the on-board network 8 by means of the auxiliary energy storage unit 6. Here, the auxiliary energy storage unit can be discharged to a voltage level which is below the voltage level of the main energy storage unit 4.

In order to be able to utilise the electric energy stored in the auxiliary energy storage unit 6 effectively and fully, and not only that portion which is higher than the voltage level of the main energy storage unit 4, the auxiliary energy storage unit 6 is assigned a four-quadrant DCDC converter 18 which enables the discharge of the electric energy which is stored in the auxiliary energy storage unit 6 and its feed into the on-board network 8 down to a voltage level which is below the voltage level of the main energy storage unit 4. In the best case, the electric energy of the auxiliary energy storage unit 6 is fully utilised via the four-quadrant DCDC converter 18 down to a voltage level of 0V, wherein the main energy storage unit 4 is freed from cyclical loads for as long as the electric energy in the auxiliary energy storage unit 6 is utilisable.

### LIST OF REFERENCE NUMERALS

1 Electric system
2 Generator
4 Main energy storage unit
6 Capacitive auxiliary energy storage unit
8 On-board network
10 Consumers
12 Control device
14 DCDC converter

1-3. (canceled)

4. A motor vehicle comprising:
an on-board network (8);
a main energy storage unit (4);
an auxiliary energy storage unit (6); and
a number of consumers (10) which are operated with electric energy via the on-board network (8) and a main energy storage unit (4) and an auxiliary energy storage unit (6), wherein the auxiliary energy storage unit (6) is connected on the consumer side via a four-quadrant DCDC converter (14) with the on-board network (8).

5. The motor vehicle according to claim 4, wherein the four-quadrant DCDC converter (14) is configured so that the auxiliary energy storage unit (6) assigned to it can be discharged to a voltage level which is below the voltage level of the main energy storage unit (4).

6. The motor vehicle according to claim 5, wherein the four-quadrant DCDC converter (14) is configured so that the auxiliary energy storage unit (6) assigned to it can be discharged to a voltage level of 0V.
